(19) United States
(12) Patent Application Publication
(10) Pub. No.: US 2014/0244267 A1
(43) Pub. Date: Aug. 28, 2014

(54) INTEGRATION OF USER ORIENTATION INTO A VOICE COMMAND SYSTEM

(71) Applicant: AVAYA INC., Basking Ridge, NJ (US)

(72) Inventor: Avram Levi, Hoboken, NJ (US)

(73) Assignee: AVAYA INC., Basking Ridge, NJ (US)

(21) Appl. No.: 13/777,781

(22) Filed: Feb. 26, 2013

(51) Int. Cl. G10L 15/22

(52) U.S. Cl. CPC G10L 15/22
USPC 704/275

(57) ABSTRACT

Embodiments disclosed herein provide systems and methods for integrating user orientation into a voice command system. In a particular embodiment, a method provides receiving audio information spoken by a user during a time period and determining whether the audio information includes a voice command. The method further provides determining a first orientation of the user during the time period and complying with the voice command based on the first orientation.

### TECHNICAL BACKGROUND

Voice command systems allow individuals to control systems and/or devices using spoken commands. The spoken commands may be individual words or sequences of words that indicate a desired action. In a simple example, a user may speak a command, such as “play track number 2,” in order to change a music track on a car stereo system. Other commands may correspond to other systems and functions within the user's car. As the number of possible voice controlled functions increases, so does the complexity and number of different commands needed to distinguish one controlled function from another. This increase in voice commands may hinder the ability of a user to take full advantage of a voice command system under such circumstances.

### OVERVIEW

Embodiments disclosed herein provide systems and methods for integrating user orientation into a voice command system. In a particular embodiment, a method provides receiving audio information spoken by a user during a time period and determining whether the audio information includes a voice command. The method further provides determining a first orientation of the user during the time period and complying with the voice command based on the first orientation.

In some embodiments, complying with the voice command based on the first orientation comprises complying with the voice command if the first orientation indicates that the user is voicing the command to the voice command system and ignoring the voice command if the first orientation does not indicate that the user is voicing the command to the voice command system.

In some embodiments, an action requested by the voice command includes a plurality of sub-actions, wherein each sub-action of the plurality of sub-actions is associated with at least one of a plurality of possible orientations.

In some embodiments, complying with the voice command based on the first orientation comprises determining a sub-action associated with the first orientation and triggering the sub-action.

In some embodiments, each of the plurality of sub-actions indicates a different subject for the action.

In some embodiments, each of the plurality of sub-actions indicates different details regarding how the action should be performed.

In some embodiments, the audio information is captured by a plurality of microphones placed at known locations and wherein each microphone of the plurality of microphones captures a portion of the audio information.

In some embodiments, determining the first orientation comprises processing the portions of the audio information to determine the orientation of the user with respect to the known locations of the plurality of microphones.

In some embodiments, determining the first orientation of the user comprises capturing video of a scene that includes the user during the time period and processing the video to determine the orientation of the user with respect to the scene.

In another embodiment, a voice command system is provided. The voice command system includes an audio interface configured to receive audio information spoken by a user during a time period. The voice command system further includes a processing system configured to determine whether the audio information includes a voice command. The processing system is further configured to determine a first orientation of the user during the time period and comply with the voice command based on the first orientation.

In a further embodiment, a non-transitory computer readable medium having instructions stored thereon for operating a voice command system is provided. The instructions, when executed by the voice command system, direct the voice command system to receive audio information spoken by a user during a time period and determine whether the audio information includes a voice command. The instructions further direct the system to determine a first orientation of the user during the time period and comply with the voice command based on the first orientation.

### BRIEF DESCRIPTION OF THE DRAWINGS

FIG. 1 illustrates a voice command environment to integrate user orientation into a voice command system.

FIG. 2 illustrates an operation of the voice command environment to integrate user orientation into a voice command system.

FIG. 3 illustrates a conference room environment in an exemplary embodiment to integrate user orientation into a voice command system.

FIG. 4 illustrates an operation of the conference room environment to integrate user orientation into a voice command system.

FIG. 5 illustrates a kitchen environment in an exemplary embodiment to integrate user orientation into a voice command system.

FIG. 6 illustrates an operation of the kitchen environment to integrate user orientation into a voice command system.

FIG. 7 illustrates a voice command system for integrating user orientation.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

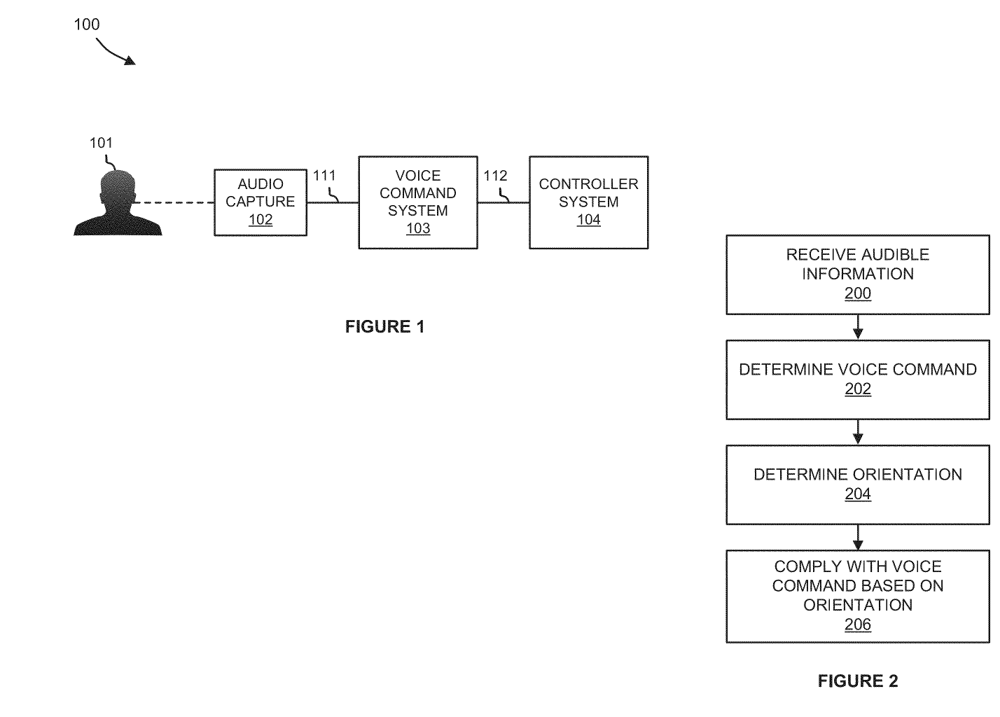

FIG. 1 illustrates voice command environment 100. Voice command environment 100 includes user 101, audio capture system 102, voice command system 103, and controller system 104. Audio capture system 102 and voice command system 103 communicate over communication link 111. Voice command system 103 and controller system 104 communicate over communication link 112. While audio capture system 102, voice command system 103, and controller system 104 are illustrated as separate systems, the functionality of each system may be integrated into fewer systems than those illustrated in FIG. 1. Similarly, the functionality of systems 102-104 may be divided among more than the three systems illustrated in FIG. 1. Systems 102-104 may also exchange communications over local area networks, such as an Ethernet network, wide area networks, such as the Internet, or some combination thereof.

In operation, voice command system 103 receives audio information from audio capture system 102. Voice command system 103 then determines whether that audio information includes a voice command by processing the audio information using any type of audio/speech recognition technology. If voice command system 103 determines that a voice command is included in the audio information, then voice command system 103 notifies controller system 104. Controller system 104 may be an audio/video system controller, a vehicle audio/navigation controller, a home automation controller, or some other type of system that may be controller by voice commands identified from a voice command system—including combinations thereof. Upon receiving notification of the command from voice command system 103, controller system 104 takes action in accordance with the command.

For example, controller system 104 may be a media center controller that controls a television set, video disk player, audio amplifier, game system, room lighting, and/or other types of systems that may exist in a media center. Voice command system 103 monitors audio captured from audio capture system 102 to determine whether user 101 spoke a voice command. In this example, voice command system 103 may determine that user 101 spoke a command for the video disk player to begin video playback. Voice command system 103 accordingly transfers a notification of the voice command to controller system 104 and controller system 104 directs the video disk player to begin video playback accordingly.

As more system elements and more features of those elements are controlled by controller system 104, the number of corresponding voice commands and the complexity of those voice commands may increase to ensure each system and feature is controlled by a unique voice command. In a simple example, a voice command to power on a system may consist of the words “power on.” This command would work fine in an environment having only one system to control. However, in environments with more than one system the command would have to further indicate a system to power on, such as “power on system x,” which is a more complex command than “power on.” Moreover, the complexity of the voice commands may further increase so as to better ensure that a sequence of words in normal speech is not inadvertently identified by voice command system 103 as being a voice command. Therefore, in order to take full advantage of controller system 104 through the use of voice command system 103, user use when instructing controller system 104.

FIG. 2 illustrates an operation of voice command environment 100 to integrate user orientation into a voice command system. Voice command system 103 receives audio information spoken by user 101 during a time period (step 200). The audio information is received from audio capture system 102 after being captured by audio capture system 102. Audio capture system 102 may be one or more microphones, or other type of audio capture equipment, placed at a location serviced by voice command system 103, such as a room, a portion of a room, a vehicle, a yard, or some other area. The audio information transferred to voice command system 103 from audio capture system 102 in real time so that voice command system 103 can promptly act on any voice commands spoken by user 101. The audio information may comprise an analog audio signal that may be digitized for processing at voice command system 103 or a digital representation of the captured analog audio signal as digitized by audio capture system 102 before being transferred to voice command system 103.

The audio information may be continually captured and transferred to voice command system 103 or may be captured in response to an indication that a voice command will be spoken. For example, user 101 may hold down a button, physical, touch screen, or otherwise, during the time period in which user 101 speaks a voice command. Audio capture system 102 responsively captures the audio information during the time that the button was pressed. Other methods of indication may also be used. In contrast, continual capture of audio information relies on voice command system 103 to identify voice commands from amongst other words and sounds that are captured by audio capture system 102 at any time.

Upon receiving the audio information, voice command system 103 determines whether the audio information includes a voice command (step 202). Voice command system 103 use any speech recognition software or hardware in order to recognize and interpret words that may be spoken in the audio information. It should be understood that the audio information may further include any background sounds that may be captured by audio capture system 102. Once words, if any, are recognized from the audio information, voice command system 103 determines whether any of the words represent a voice command. Voice command system 103 may perform this determination by comparing the recognized words to a table or list of possible voice commands for use with controller system 104. Other methods of determining whether any of the words represent a voice command may also be used.

The voice command system 103 also determines an orientation of user 101 during the time period (step 204). The orientation of user 101 may include a location of user 101 with an area, a direction that user 101's body is facing, a direction that user 101's head is facing, whether user 101 is sitting, standing, leaning, etc., position of one or more of user 101's limbs, movement of user 101's body, such as a head nod, hand wave, finger point, etc., or anything else that may describe an orientation of a person—including combinations thereof.

The time period may be any period of time that includes the time when a voice command that may be included in the audio information is spoken. Preferably, the so as to ensure the orientation is associated with the voice command. For example, an orientation of the user five or so seconds after the voice command was spoken may not be related to the voice command since user 101 has likely switched his or her attention from the voice command. In embodiments where voice command system 103 receives an indication that a voice command will be spoken, the time period may correspond to the time in which the indication is active, a length of time after the indication is first received, or some other time period corresponding to the voice command indication.

Voice command system 103 may use any method(s) of determining a user's orientation, such as sensor information, audio information, visual information, or other types of information—including combinations thereof. In some embodiments, voice command system 103 processes the audio information to determine an orientation of user 101. For example, audio capture system 102 may include multiple microphones with each microphone placed at known locations around the physical area where user 101 is located. Based on the amplitude of user 101's voice captured at each respective microphone, time differences between when the voice is captured by each microphone, or other information that can be gleaned from portions of the audio information captured by each microphone, voice command system 103 is able to calculate the orientation of user 101. In some embodiments, voice command system 103 may participate in a “learning mode” whereby sample voice commands are given to the system in various orientations known to voice command system 103 so that voice command system 103 can reference the audio information from the sample command when making the orientation determination. For example, a user may say, “test command” when in a particular location and facing a certain direction. The user may then indicate the location and direction into voice command system 103 (e.g. via a graphical user interface) so that voice command system 103 can associate the test command audio information with the location and direction.

In other embodiments, voice command system 103 may include one or more visual capture elements, such as video cameras or still photo cameras, to capture images of user 101 during the time period. In those embodiments, voice command system 103 performs image analytics on the captured video or still images in order to determine the orientation of the user during the time period. In yet further embodiments, voice command system 103 may use motion sensors, infrared sensors, or other elements to determine the orientation of user 101.

Voice command system 103 may not know that the time period includes a valid voice command before the audio information is processed to determine the existence of a voice command therein. Thus, voice command system 103 collects information required to determine the orientation of user 101 during the time period to ensure an orientation can be determined if a voice command is detected. In one embodiment, if voice command system 103 determines that the audio information for the time period includes a voice command, then voice command system 103 determines the orientation of user 101. In alternative embodiments, voice command system 103 may attempt to determine the orientation concurrently to determining whether there is a voice command in the audio information for efficiency of time just in case a voice command is recognized.

For example, if voice command system 103 is continually collecting audio information and processing the audio information for voice commands, then voice command system 103 will also continually collect any information needed to determine the orientation of user 101. If the orientation information is not simply the audio information, then the orientation information and the audio information will include time stamps to allow voice command system 103 to identify the orientation information corresponding to the time period of the audio information that includes the voice command. Once voice command system 103 determines that the audio information for the time period includes a voice command, voice command system 103 identifies the orientation information corresponding to that time period and determines the orientation of user 101 therefrom. Voice command system 103 may discard any orientation information that does not correspond to audio information that includes a voice command.

If voice command system 103 determines that a voice command is included in the audio information, then voice command system 103 complies with the voice command based on the orientation (step 206). In other words, voice command system 103 uses the orientation of user 101 to further determine what user 101 intends by the voice command and notifies controller system 104 accordingly. In some embodiments, the orientation of user 101 allows the action requested by the voice command to be further defined as one of a plurality of sub-actions by the orientation of user 101. A sub-action may indicate a subject, such as a system or device, on which or with which the action will be performed. Alternatively or additionally, a sub-action may indicate further details regarding how the action should be performed, such as indicating that a channel selection should be increased as opposed to decreased if a channel selection voice command is received.

In other words, while the voice command itself indicates an action, the orientation may indicate how the action should be performed and/or on what system or system element the action should be performed. Using the simple “power on” example from above, the voice command “power on” indicates the action and the orientation of user 101 indicates the sub-action, wherein the sub-action corresponds to the system that user 101 wants to be powered on. Thus, instead of user 101 having to speak “system x” in addition to “power on” to designate system x, the orientation of user 101 may indicate the system x is the desired system. Specifically, user 101 may be facing, looking at, or pointing to system x when the voice command “power on” is spoken. Therefore, user 101 needs only to say “power on” for voice command system 103 trigger controller system 104 to power on system x. Likewise, if the orientation of user 101 indicates system y when user 101 says “power on,” then voice command system 103 will determine that the orientation of user 101 is associated with system y and trigger controller system 104 to power on system y.

In some embodiments, the orientation of user 101 may indicate whether or not user 101 is speaking to voice command system 103. If the orientation indicates that user 101 is voicing the command to voice command system 103, then voice command system 103 will comply with the command by notifying controller system 104 of the command so that controller system 104 can act accordingly. Alternatively, if the orientation indicates that user 101 is not voicing the command to the voice command system 103, as may be the case if the wording of a voice command happened to occur in user 101's normal conversation, then voice command system 103 ignores the voice command and does not notify controller system 104. Once again using the “power on” example, the fact that user 101's orientation indicates system x also indicates that “power on” spoken by user 101 is intended for voice command system 101. In other examples, the orientation of user 101 may indicate a designated area to which user 101 should direct his or her orientation if intending to speak a command to voice command system 103, such as a particular microphone, system element, or even an ambiguously selected area of a room. Likewise, voice command system 103 may only accept voice commands from users located in designated areas. In yet further examples, voice command system 103 may determine that user 101 is speaking a voice command to system 103 if the orientation of user 101 is most likely not speaking to anyone or anything else, such as other people, pets, or telephones within a same room.

In a further embodiment, voice command system 103 may operate as a security measure, such as password protection for a computer system or doorway. In the case of a computer, systems 1002-104 may all be included in the computer and user 101 speaks a username and/or password. The user name and password is interpreted as the voice command requesting entry into the computer. Voice command system 103 determines the orientation of user 101 as part of an additional level of security. For example, in order to gain entrance to the computer, voice command system 103 requires that the username be spoken on the left side of the computer monitor and the password be spoken on the right. If user 501 speaks the username and password in accordance with these orientation restrictions, then voice command system 103 triggers controller system 104 to allow user 501 access to the computer. However, if user 501's orientation does not comply with the orientation restrictions, then voice command system 103 does not trigger controller system 104 to allow access.

Advantageously, user 101 does not need to remember one of many potentially long command strings in order to indicate sub-actions for voice command system 103. Rather, user 101 can simply speak a basic command and voice command system 103 will recognize any sub-actions for that command based on the orientation of user 101.

Referring back to FIG. 1, voice command system 103 comprises a computer processing system and communication interface. Voice command system 103 may also include other components such a router, server, data storage system, and power supply. The communication interface comprises circuitry for communicating with audio capture system 102 and controller system 104. Voice command system 103 may reside in a single device or may be distributed across multiple devices. Voice command system 103 is shown externally to controller system 103, but system 103 could be integrated within the components of controller system 102.

Controller system 103 comprises a computer processing system and communication interface. Controller system 103 may also include other components such a router, server, data storage system, and power supply. Controller system 103 may reside in a single device or may be distributed across multiple devices.

Communication link 112 uses metal, glass, air, space, or some other material as the transport media. Communication link 112 could use various communication protocols, such as Time Division Multiplex (TDM), Internet Protocol (IP), Ethernet, communication signaling, CDMA, EVDO, WIMAX, GSM, LTE, WIFI, HSPA, Bluetooth, or some other communication format—including combinations thereof. Communication link 112 could be a direct link or may include intermediate networks, systems, or devices.

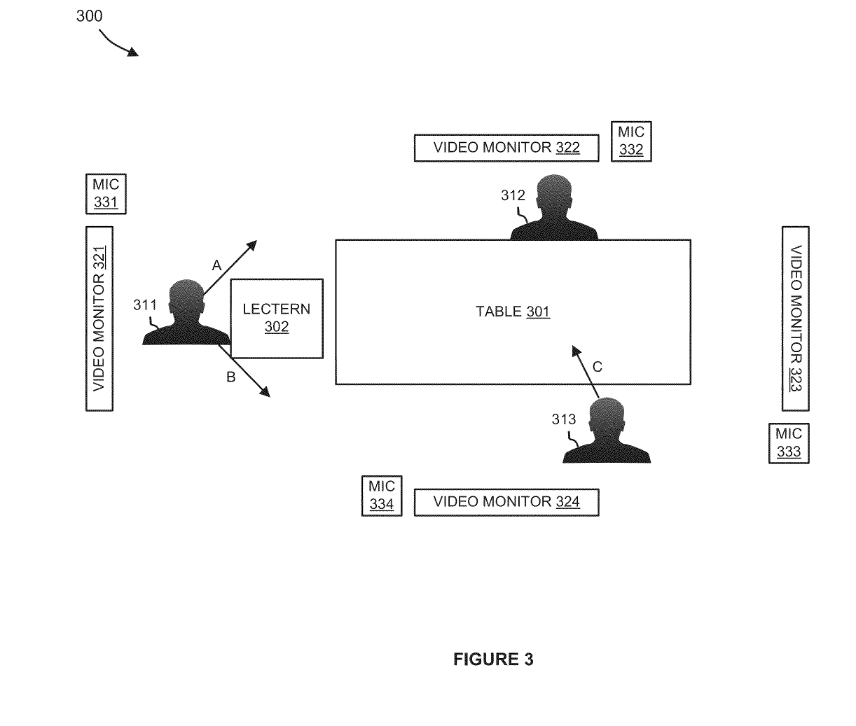

FIG. 3 illustrates conference room 300 in an exemplary embodiment of voice command environment 100. Conference room 300 includes table 301, lectern 302, users 311-313, video monitors 332, and microphones 331-334. Though not shown, conference room 300 may be bounded by walls, doors, windows, or may otherwise be defined as a conference room space to voice command system 103. Microphones 331-334 are an array of microphones that represent an example of audio capture system 102 in this embodiment. Microphones 331-334 may communicate with voice command system 103 over wired or wireless connections. Similarly, video monitors 321-324 may also communicate with controller system 104 over wired or wireless connections. Video monitors 321-324 comprise CRT, LCD, Plasma, OLED, projector, or any other type of viewing device—including combinations thereof. Voice command system 103 and controller system 104 may be located within conference room 300 or one or more of systems 103 and 104 may be located elsewhere and communicate with elements in conference room 300 over local and/or wide area networks. Thus, voice command system 103 and controller system 104 do not necessarily need to be located within conference room 300.

In operation, video monitors 321-324 provide visual information, and possibly also audible information, to users in conference room 300. Video monitors 321-324 are controlled by controller system 104. Controller system 104 may be able to control power on/off functionality, volume changes, channel changes, video sources, picture modes, or any other type of functionality that may be supported by a video monitor—including combinations thereof. Monitors 321-324 may be controlled in groups of two or more or on an individual basis. Controller system 104 communicates with voice command system 103 to provide users in conference room 300 with voice command functionality for at least some of the functions of video monitors 321-324. Controller system 104 and voice command system 103 may also be able to control functions of other elements that are not illustrated in conference room 300, such as a video disk player, cable box, telephone, room lighting, window coverings, and other types of controllable elements.

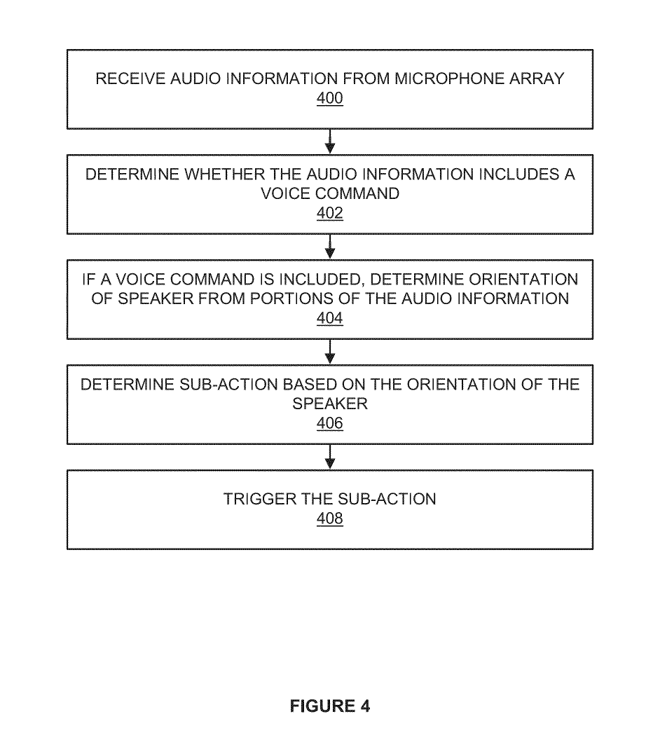

FIG. 4 illustrates an operation of voice command system 103 and controller 104 for controlling video monitors 321-324. In this embodiment, user 311 speaks a voice command to power on a video monitor. The words in the spoken voice command do not indicate which of the four monitors 321-324 the user wants turned on. Microphones 331-334 each receive the audio of the command and transfer the received audio to voice command system 103. The audio received from each makes up a portion of the audio information received by voice command system 103 (step 400). Voice command system 103 then determines that the audio information received from microphones 331-334 includes a power on voice command (402).

Upon determining that the audio information does include a voice command, voice command system 103 processes the audio information to determine an orientation of user 311 from the portions of the audio information received from each of microphones 331-334 (step 404). To determine the orientation of user 311, the locations microphones 331-334 are known to voice command system 103 before voice command system 103 determines the orientation of user 311. The locations of the microphones may be provided to voice command system 103 by a person, such as an administrator or technician, who set up conference room 300 for receiving voice commands. While microphones 331-334 are shown located near video monitors 321-324, microphones 331-334 do not necessarily need to be located next to controlled devices in order for voice command system 103 to determine the orientation of the user. In one example, the microphones may be arranged in a geometric configuration, such as a line, triangle, cube, etc., that allows voice command system 103 to determine user orientations based on audio information received by each microphone. Regardless of the chosen location arrangement, the microphone location information may be input into a user interface of voice command system 103 or may be received by any other means of receiving data in a computer system. Voice command system 103 is therefore able to analyze the individual portions of the audio information to determine an orientation of user 311 in relation to microphones 331-334. In some embodiments, voice command system 103 translates orientation of user 311 into an orientation within conference room 300.

In this example, voice command system 103 determines that user 311 is located in the position illustrated in FIG. 3 and is facing in the direction indicated by arrow A. Voice command system 103 then determines a sub-action of user 311's power on command from this orientation (step 406). The sub-actions for the power-on command in this embodiment define which of monitors 331-334 are to be powered on. Similar to what was described above for microphones 331-334, voice command system 103 is aware of the locations of monitors 321-324 within conference room 300. In some embodiments, voice command system 103 may only know the locations of monitors 321-324 relative to microphones 331-334 while in other embodiments voice command system 103 may know the locations within conference room 300.

Since arrow A is directed at monitor 322, voice command system 103 determines that monitor 322 is the monitor that user 311 desires to have turned on. Accordingly, voice command system 103 triggers controller 104 to power on video monitor 322 (step 408). In an alternative example, user 311 may have been facing in the direction of video monitor 324 as indicated by arrow B. In that case, voice command system 103 would trigger controller system 104 to power on video monitor 324 instead of video monitor 322.

In a further example, user 313 speaks a command to increase audio volume. Sub-actions for increasing the volume in this example correspond to which of monitors 321-324 should have the volume increased. In this example, user 313 is facing video monitor 322 when speaking the command, as indicated by arrow C. Voice command system 103 therefore determines that user 313 wants an increase in the volume of the audio from video monitor 322. In some embodiments, voice command system 103 may further be able to determine whether user 313 nods his or her head up or down. In those embodiments, the user may only need to speak a command like “volume” and sub-actions for the volume command may include not only which monitors volume should be changed but also whether the volume should go up or down as indicated by the direction of a head nod while speaking.

In some embodiments, voice command system 103 is configured to only accept voice commands from users located around lectern 302 (i.e. where user 311 is located). Therefore, if a voice command is received from users 312-313, then voice command system 103 will ignore that command since neither user 312 nor 313 is located around lectern 302. In an example, to enable such a configuration, voice command system 103 may prompt users 311-313 for an indication of which user will be giving commands to voice command system 103. In response to an indication from user 311 that user 311 will be giving voice commands, voice command system 103 configures itself to only accept voice commands from where user 311 made the indication (i.e. behind lectern 302). This configuration may last indefinitely, for a designated period of time, until user 311 indicates an end to the configuration, until the next system boot cycle, or until the configuration is ended by some other means.

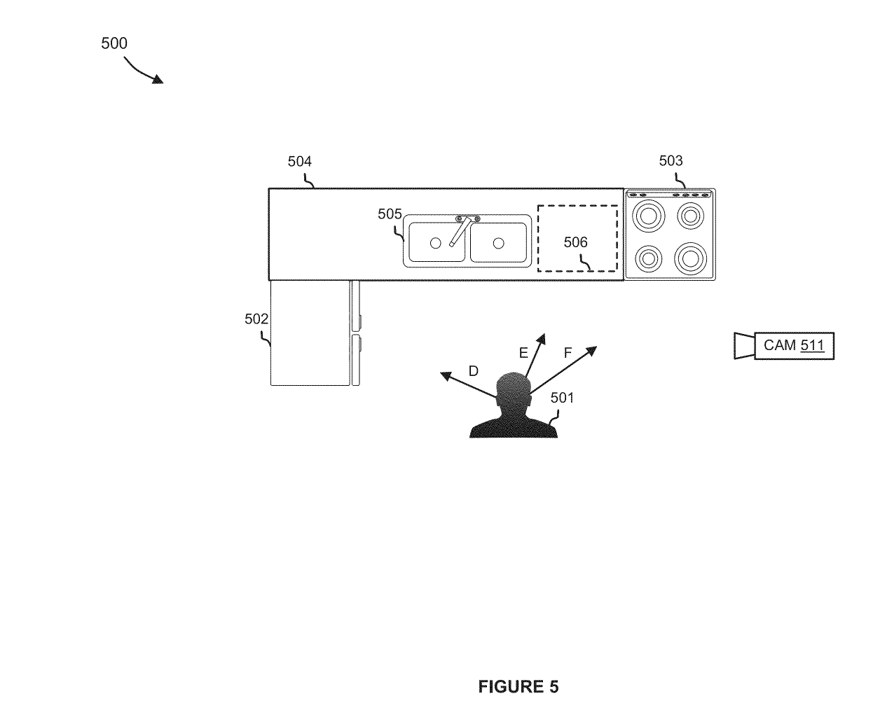

FIG. 5 illustrates kitchen 500 in an exemplary embodiment of voice command environment 100. Kitchen 500 includes user 501, refrigerator 502, oven range 503, countertop 504, sink 505, dishwasher 506, and video camera 511. Though not shown, kitchen 500 may be bounded by walls, doors, windows, or may otherwise be defined as a kitchen space to voice command system 103. A microphone included in camera 511 represents an example of audio capture system 102 in this embodiment. Camera 511 may communicate with voice command system 103 over wired or wireless connections. Similarly, fridge 502, range 503, and dishwasher 506 may also communicate with controller system 104 over wired or wireless connections. Voice command system 103 and controller system 104 may be located within kitchen 500 or one or more of systems 103 and 104 may be located elsewhere and communicate with elements in kitchen 500 over local and/or wide area networks. Thus, voice command system 103 and controller system 104 do not necessarily need to be located within kitchen 500.

In operation, controller system 104 controls functions of appliances 502, 503, and 506. Voice command system 103 provides voice command functionality to controller system 104 allowing a user in the kitchen to use voice commands to operate appliances 502, 503, and 506. In this embodiment, the functionality of audio capture system 102 is included as a microphone in video camera 511, although, in other embodiments, microphone(s) may be located elsewhere, such as within appliances 502, 503, and 506.

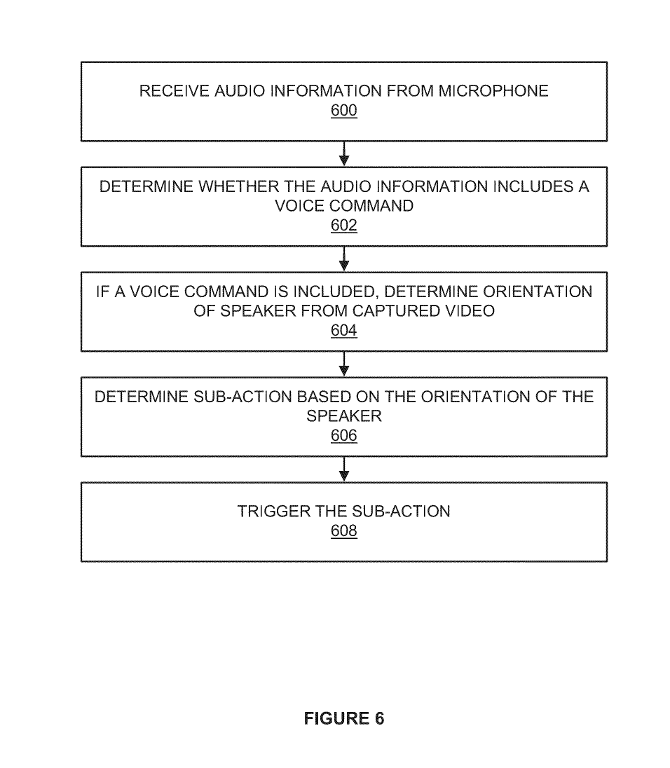

FIG. 6 illustrates an operation of voice command system 103 and controller 104 for controlling appliances 502, 503, and 506. In this operation, voice command system 103 receives audio information captured by the microphone in camera 511 (step 600). Voice command system 103 then determines whether the audio information includes a voice command spoken by user 501 or any other user that may enter kitchen 500 (step 602). In this example, voice command system 103 determines that user 501 has spoken a command. Specifically, voice command system 103 determines that user 501 has spoken the command “start.”

Since a voice command is included in the audio information, voice command system 103 determines an orientation of user 501 from the video captured of user 501 while user 501 was in the process of speaking the voice command (step 604). If multiple users are present in kitchen 511, then voice command system 103 may first need to determine which of the users spoke the command before determining the orientation of the user. In this example, the orientation of user 501 is represented by arrow E, which indicates that the orientation of the user is directed at dishwasher 506. The orientation may indicate dishwasher 506 because user 501 is looking at dishwasher 506, facing dishwasher 506, pointing at dishwasher 506, nodding towards dishwasher 506, walking towards dishwasher 506, or any other way that a user's orientation may indicate dishwasher 506. To determine the orientation, voice command system 103 may use any type of image and/or video analytics to analyze the video captured of the scene comprising kitchen 500 during a time period in which the voice command was spoken.

Accordingly, voice command system 103 has determined that the voice command action is “start” and further determines a sub-action based on the orientation of user 501 (step 606). Since the orientation of user 501 indicates dishwasher 506, the sub-action associated with that orientation is determined to be an action to start the wash cycle on the dishwasher. Therefore, voice command system 103 triggers controller system 104 to start the wash cycle on the dishwasher (step 608).

In an alternative example, user 501 also speaks the start command but the orientation of user 501 indicates oven range 503 as illustrated by arrow F. Voice command system 103 determines that the sub-action of the start command action associated with an orientation indicating oven range 503 is a sub-action to start the cook timer on oven range 503. Hence, in this example, voice command system 103 triggers controller system 104 to start the timer on oven range 503.

In a further example, user 501 speaks the start command and the orientation of user 501 indicates refrigerator 502 as illustrated by arrow D. Voice command system 103 determines that no sub-action of the start command action is associated with an orientation indicating refrigerator 502. Since no sub-action is determined, voice command system 103 thereby determines that user 501 is not speaking a command to voice command system 103. Rather, user 501 may have simply said the word start in some other capacity, such as within another conversation. In alternative embodiments, if voice command system 103 determines that the start command was indeed directed at voice command system 103 despite user 501's orientation, then voice command system 103 may prompt user 501 (e.g. play an audible prompt through a speaker or otherwise) to provide further information for the voice command. Such a prompt may ask the user to speak the command again and provide a new orientation, may ask the user to speak additional command details, or some other means for prompting a user for more information.

In yet another example, voice command system 103 determines that user 501 has spoken a command “temperature,” which corresponds to a temperature action. Voice command system 103 further determines an orientation of user 501 through camera 511. In this example, the orientation indicates that user 501 is holding his or her hand out in the direction of oven range 503 as though gripping an invisible nob in the air. Additionally, the orientation indicates that user 501 is turning the non-existent invisible nob clockwise. Voice command system 103 determines that this nob turning orientation of user 501 corresponds to a sub-action of turning up the temperature on the oven in oven range 503. Accordingly, voice command system 103 triggers controller to turn up the temperature on the oven. In some embodiments, voice command system 103 would continue to trigger the increase of temperature until user 501's orientation is not longer turning the nob clockwise. Conversely, if user 501 were turning the nob counterclockwise, then voice command system 103 would have determined that the sub-action was decreasing the temperature.

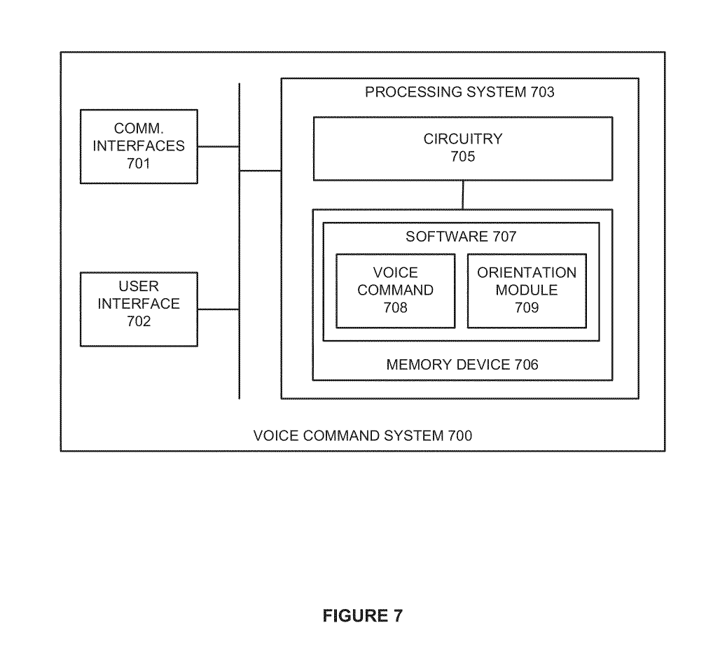

FIG. 7 illustrates voice command system 700. Voice command system 700 is an example of voice command system 103, although voice command system 103 may use alternative configurations. Voice command system 700 comprises communication interface 701, user interface 702, and processing system 703. Processing system 703 is linked to communication interface 701 and user interface 702. Processing system 703 includes processing circuitry 705 and memory device 706 that stores operating software 707.

Communication interface 701 comprises components that communicate over communication links, such as network cards, ports, RF transceivers, processing circuitry and software, or some other communication devices. Communication interface 701 may be configured to communicate over metallic, wireless, or optical links. Communication interface 701 may be configured to use TDM, IP, Ethernet, optical networking, wireless protocols, communication signaling, or some other communication format—including combinations thereof. Communication interface 701 is configured to receive audio information from an audio capture system, such as audio capture system 102, and, in some embodiments, video/images from an image capture system, such as video camera 511. The audio information and the video/images may be received from their respective systems using the same or different communication formats. In some embodiments, communication interface 701 is further configured to exchange communications with a controller system, such as controller system 104 described above.

User interface 702 comprises components that interact with a user. User interface 702 may include a keyboard, display screen, mouse, touch pad, or some other user input/output apparatus. User interface 702 may be omitted in some examples.

Processing circuitry 705 comprises microprocessor and other circuitry that retrieves and executes operating software 707 from memory device 706. Memory device 706 comprises a non-transitory storage medium, such as a disk drive, flash drive, data storage circuitry, or some other memory apparatus. Operating software 707 comprises computer programs, firmware, or some other form of machine-readable processing instructions. Operating software 707 includes voice command module 708 and orientation module 709. Operating software 707 may further include an operating system, utilities, drivers, network interfaces, applications, or some other type of software. When executed by circuitry 705, operating software 707 directs processing system 703 to operate voice command system 700 as described herein.

In particular, voice command module 708 directs processing system 703 to receive audio information spoken by a user during a time period and determine whether the audio information includes a voice command. Orientation module 709 directs processing system 703 to determine a first orientation of the user during the time period. Voice command module 708 further directs processing system 703 to comply with the voice command based on the first orientation.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a voice command system, comprising:
receiving audio information spoken by a user during a time period;
determining whether the audio information includes a voice command;
determining a first orientation of the user during the time period; and
complying with the voice command based on the first orientation.

2. The method of claim 1, wherein complying with the voice command based on the first orientation comprises:
complying with the voice command if the first orientation indicates that the user is voicing the command to the voice command system; and
ignoring the voice command if the first orientation does not indicate that the user is voicing the command to the voice command system.

3. The method of claim 1, wherein an action requested by the voice command includes a plurality of sub-actions, wherein each sub-action of the plurality of sub-actions is associated with at least one of a plurality of possible orientations.

4. The method of claim 3, wherein complying with the voice command based on the first orientation comprises:
determining a sub-action associated with the first orientation; and
triggering the sub-action.

5. The method of claim 4, wherein each of the plurality of sub-actions indicates a different subject for the action.

6. The method of claim 4, wherein each of the plurality of sub-actions indicates different details regarding how the action should be performed.

7. The method of claim 1, wherein the audio information is captured by a plurality of microphones placed at known locations and wherein each microphone of the plurality of microphones captures a portion of the audio information.

8. The method of claim 7, wherein determining the first orientation comprises:
processing the portions of the audio information to determine the orientation of the user with respect to the known locations of the plurality of microphones.

9. The method of claim 1, wherein determining the first orientation of the user comprises:
capturing video of a scene that includes the user during the time period; and
processing the video to determine the orientation of the user with respect to the scene.

10. A voice command system, comprising:
an audio interface configured to receive audio information spoken by a user during a time period;
a processing system configured to determine whether the audio information includes a voice command, determine a first orientation of the user during the time period, and comply with the voice command based on the first orientation.

11. The voice command system of claim 10, wherein, to comply with the voice command based on the first orientation, the processing system is configured to:
comply with the voice command if the first orientation indicates that the user is voicing the command to the voice command system; and
ignore the voice command if the first orientation does not indicate that the user is voicing the command to the voice command system.

12. The voice command system of claim 10, wherein an action requested by the voice command includes a plurality of sub-actions, wherein each sub-action of the plurality of sub-actions is associated with at least one of a plurality of possible orientations.

13. The voice command system of claim 12, wherein, to comply with the voice command based on the first orientation, the processing system is configured to:
determine a sub-action associated with the first orientation; and
trigger the sub-action.

14. The voice command system of claim 13, wherein each of the plurality of sub-actions indicates a different subject for the action.

15. The voice command system of claim 13, wherein each of the plurality of sub-actions indicates different details regarding how the action should be performed.

16. The voice command system of claim 10, wherein the audio information is captured by a plurality of microphones placed at known locations and wherein each microphone of the plurality of microphones captures a portion of the audio information.

17. The voice command system of claim 16, wherein, to determine the first orientation, the processing system is configured to:
process the portions of the audio information to determine the orientation of the user with respect to the known locations of the plurality of microphones.

18. The voice command system of claim 10, further comprising:
a video interface configured to receive video of a scene that includes the user during the time period; and
wherein, to determine the first orientation of the user, the processing system is configured to process the video to determine the orientation of the user with respect to the scene.

19. A non-transitory computer readable medium having instructions stored thereon for operating a voice command system, wherein the instructions, when executed by the voice command system, direct the voice command system to:
receive audio information spoken by a user during a time period;
determine whether the audio information includes a voice command;
determine a first orientation of the user during the time period; and
comply with the voice command based on the first orientation.

20. The non-transitory computer readable medium of claim 19, wherein, to comply with the voice command based on the first orientation, the instructions direct the voice command system to:
comply with the voice command if the first orientation indicates that the user is voicing the command to the voice command system; and
ignore the voice command if the first orientation does not indicate that the user is voicing the command to the voice command system.
